(19) United States
(12) Patent Application Publication
(10) Pub. No.: US 2018/0038734 A1
(43) Pub. Date: Feb. 8, 2018

(54) SYSTEM AND METHOD FOR THE HARMONIZATION OF EVALUATION BETWEEN TWO OR MORE DIGITAL DATA GATHERING DEVICES

(71) Applicant: Don Atkinson, Delano, MN (US)

(72) Inventor: Don Atkinson, Delano, MN (US)

(21) Appl. No.: 15/786,659

(22) Filed: Oct. 18, 2017

Related U.S. Application Data
(63) Continuation-in-part of application No. 14/939,535, filed on Nov. 12, 2015, now abandoned.
Application No. 14/939,535 is a continuation of application No. 14/863,520, filed on Sep. 24, 2015, now abandoned.

(51) Int. Cl. G01J 3/52; H04N 5/225; H04N 17/00; G01J 3/50; G06T 7/80

(52) U.S. Cl. CPC G01J 3/524; G01J 3/50; G06T 7/80; H04N 17/002; H04N 5/2256

(57) ABSTRACT

A system and method for harmonizing evaluation results between a plurality of separate digital data gathering devices includes first and second digital data gathering devices each having a lens through which the digital data gathering devices are operative to accept incoming light. The system further includes a calibration device to perform a first initial calibration of the first digital data gathering device during a first initial calibration exposure of the first digital data gathering device, and a second initial calibration of the second digital data gathering device during a second initial calibration exposure of the second digital data gathering device. The first and the second digital data gathering devices adjust subsequent exposures in dependence upon the first and the second initial calibrations, such that the subsequent exposures obtained by the first and the second digital data gathering devices are harmonized with one another through use of the common calibration device.

### CROSS-REFERENCE TO RELATED APPLICATIONS

This application is a continuation-in-part of U.S. Utility application Ser. No. 14/939,535, filed Nov. 12, 2015, which is a continuation of U.S. Utility application Ser. No. 14/863,520, filed on Sep. 24, 2015, which claims the benefit of U.S. Provisional Application Ser. No. 62/054,479, filed on Sep. 24, 2014, which are herein incorporated by reference in their entirety.

### FIELD OF THE INVENTION

The present invention relates generally to a system and method for uniform illumination and evaluation between two or more digital data gathering devices and, more particularly, to a system and method for harmonizing evaluation results between a plurality of separate digital data gathering devices.

### BACKGROUND OF THE INVENTION

As is well understood, pictures, as opposed to mere words, are capable of quickly conveying large amounts of information regarding an imaged item or surface. Indeed, there are many differing recording devices that are known to assist a user in recording various types of visual information, such as color, about an item or surface of interest.

Cameras, specifically digital cameras, are currently the most commonly utilized image gathering devices, and can be found in many commonly owned and carried products, such as smart phones and/or tablet devices.

As will be appreciated by anyone who has owned one or more devices capable of gathering digital information, the digital image information gathered by an integrated digital camera of one device is oftentimes much different than the digital image information gathered by the integrated digital camera of another device.

That is, the resultant images of a particular item or surface can oftentimes exhibit drastically different parameters and qualities, from one imaging operation to the next, in direct dependence upon many factors, including: the type and technological capabilities of the digital data gathering devices used for each imaging, as well as the ambient lighting environment that existed when the imaging operations took place.

Indeed, even digital data gathering devices of the same make or model, utilizing the same or similar technology and software processing techniques, may give drastically different results from an imaging operation due to the individual environmental condition or contamination of each such digital data gathering device.

Many industries utilize information obtained from digital data gathering devices to help in selecting appropriate and complimentary colors, medical procedures or product matching. Thus, inaccurate or variable results from the imaging of a common item or surface can result in imprecise color matching and medical diagnostic evaluations, as well as generally causing much confusion in the marketplace.

Presently, apparatuses exist that perform a self-calibration process in order to maximize their operational capabilities. Pending U.S. application 2013/0300919 to Fletcher is one example of a known self-calibrating digital device. It will be readily appreciated that Fletcher's calibration routine is wholly self-contained, and is never concerned with harmonizing the results of a digital data gathering event with the result(s) from separate digital data gathering devices. Indeed, there is no recognition at all within Fletcher of calibrating two or more devices with one another, or of any method or apparatus that would enable the same. Thus, while Fletcher may arguably teach the calibration of Fletcher's device itself, Fletcher is completely silent on any method or apparatus that would enable two differing digital devices to be assured of having consistent operational results, as is enabled by the present invention.

Accordingly, there is a need for a system and method to ensure that the technical parameters of every image recorded by a digital data gathering device is consistent, from device to device, regardless of the technology or environmental condition of the differing digital data gathering devices that may be employed to record such an image.

### SUMMARY OF THE INVENTION

It is an object of the present invention to provide a system and method for providing uniform illumination to a data gathering device.

It is another object of the present invention to provide a system and method for providing a uniform illumination environment for a digital data gathering device, such as the camera of a smart phone or tablet device.

It is another object of the present invention to provide a system and method for ensuring that every digital data gathering device can be independently calibrated to a uniform standard.

It is another object of the present invention to provide the light-tight calibration of a digital data gathering device in accordance with a predetermined standard.

It is another object of the present invention to provide a system and method for first and second digital data gathering devices (such as, but not limited to such as the camera of a smart phone or tablet devices), each having a lens through which the digital data gathering devices are operative to accept incoming light. The system further includes a calibration device to perform a first initial calibration of the first digital data gathering device during a first initial calibration exposure of the first digital data gathering device, and a second initial calibration of the second digital data gathering device during a second initial calibration exposure of the second digital data gathering device. The first and the second digital data gathering devices adjust subsequent exposures in dependence upon the first and the second initial calibrations, such that the subsequent exposures obtained by the first and the second digital data gathering devices are harmonized with one another through use of the common calibration device.

These and other objects, features, and advantages of the present invention will become apparent in light of the detailed description of the best mode embodiment thereof, as illustrated in the accompanying drawings.

### BRIEF DESCRIPTION OF THE DRAWING

FIG. 1 illustrates a cell phone device having a removable protective case and light shroud integrated therewith, in accordance with one embodiment of the present invention.

FIG. 2 is an opposing view of the cell phone and integrated light shroud shown in FIG. 1.

FIG. 3 illustrates a calibration disk, in accordance with one embodiment of the present invention.

FIG. 4 illustrates an alternative design of the integrated light shroud, in accordance with a differing embodiment of the present invention.

FIG. 5 illustrates one alternative embodiment of the light shroud and related calibration markings.

Other features and advantages of the present invention will become apparent from the following detailed description, taken in conjunction with the accompanying drawings, which illustrate, by way of example, the principals of the invention.

### DETAILED DESCRIPTION OF THE PREFERRED EMBODIMENTS

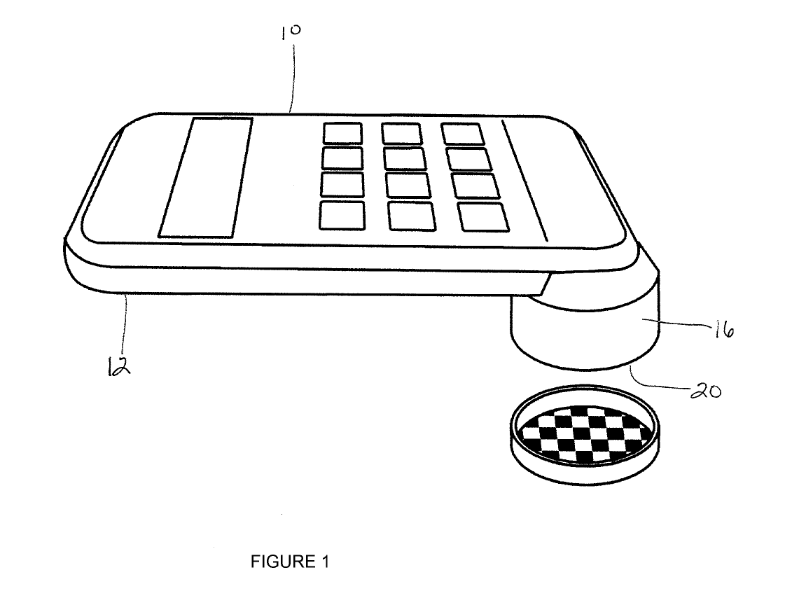

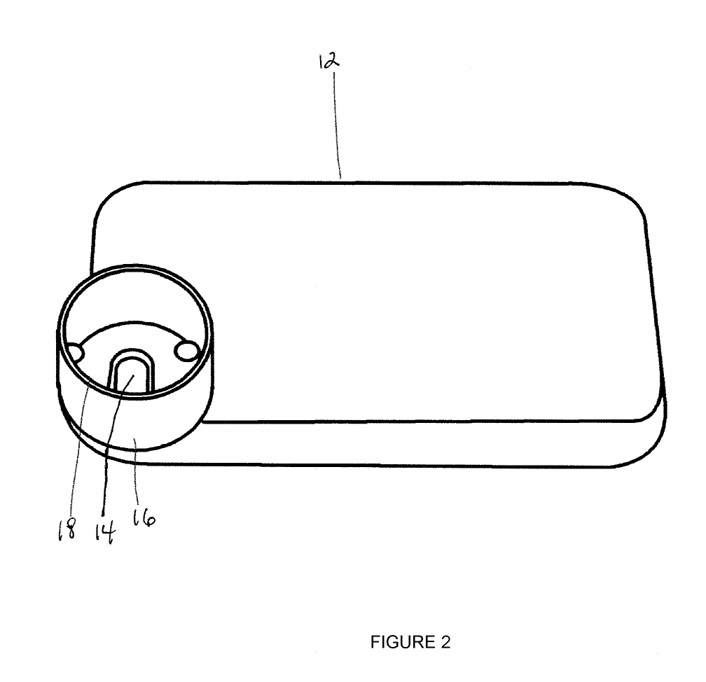

FIG. 1 illustrates a known cell phone device 10 having a removable protective case 12 attached thereon, in accordance with one embodiment of an evaluation apparatus of the present invention. As shown in FIG. 1, the removable protective case 12 is provided with an outwardly extending light shroud and enclosing wall 16. The cell phone 10 is also equipped with a digital data gathering device, such as but not limited to a digital camera 14, best seen in FIG. 2. The light shroud and enclosing wall 16 is preferably arranged to substantially surround the camera lens of the camera 14 in a first position when the protective case 12 is affixed to the cell phone 10. It will be readily appreciated that the light shroud and enclosing wall 16 may be selectively removed from close association to the camera lens, when occupying a second position in which the protective case 12 is removed from the cell phone 10.

A plurality of light emitting elements 18 are positioned inside of the light shroud 16 and serve to selectively illuminate the inside of the light shroud 16 during a calibration or imaging operation, as will be discussed in more detail later. In the preferred embodiment, the illumination elements 18 are envisioned to be LED's, however it will be readily appreciated that the illumination elements may be any type of light emitting elements without departing from the broader aspects of the present invention.

As will also be appreciated, when a substantial entirety of the distal, annular edge 20 of the light shroud 16 is pressed against the surface of an item/object, the light shroud 16 effectively shields the camera 14 from all ambient light. In this manner, the protective case 12 and the light shroud 16 selectively provide the camera 14 with a uniform, light-tight environment.

The creation of a light-tight environment around the lens of the camera 16 is an important aspect of the present invention as it ensures that all image capture is accomplished utilizing only the light emitted from the illumination elements 18. Thus, each image capture can be accomplished with exactly the same, known parameters, light values and temperature profiles, resulting in consistent and repeatable data gathering by the camera 14. With respect to the evaluation apparatus of the present invention, it will be readily appreciated that the image capture by the digital data gathering device, in the form of the integrated camera 14, amounts to the capture of digital data pertaining to one or more physical characteristics of the item/object that is imaged, such as color, heat signature or other medical information.

The ability of the present invention to provide any digital data gathering device with a consistent and repeatable light environment within which to perform image capture does not guarantee, however, that the image that is captured is consistent with other digital data gathering devices or known industry standards. Thus, in order to ensure that, for example, the color of an imaged fabric is properly recorded by the camera 14, it is therefore necessary to calibrate the digital data gathering device prior to image capture.

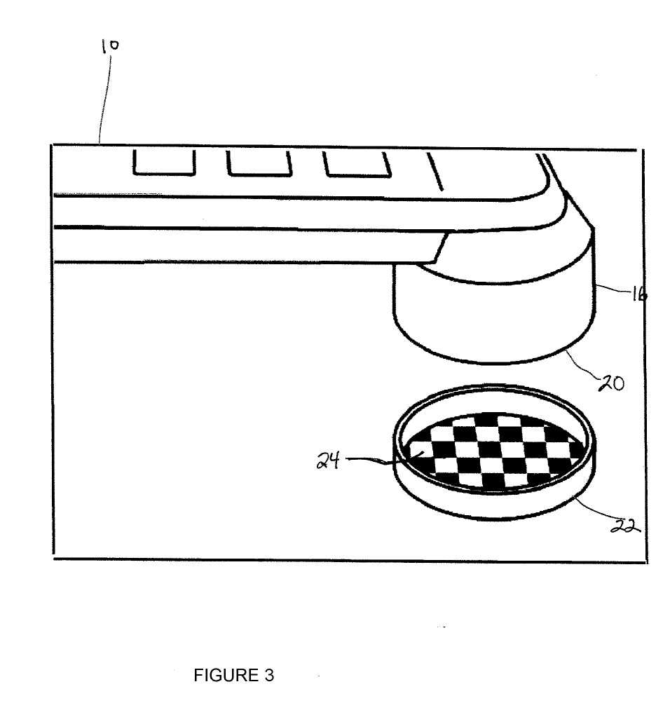

FIG. 3 illustrates a calibration assembly that includes a calibration disk 22, in accordance with one embodiment of the present invention. As shown in FIG. 3, the calibration disk 22 is sized to be securely and releasably attached to the distal, annular edge 20 of the light shroud 16 during a calibration operation. The disk 22 does not permit light emitted from the illumination elements 18 to pass through itself. Rather, the disk 22 is provided with a plurality of gray-scale markings 24 on the side facing the camera 14 so that light from the illumination elements 18 is reflected back from the gray-scale markings 24 and recorded by the camera 14. The gray-scale markings 24 preferably represent the industry standards of a chosen industry and could be of any orientation, arrangement or shading without departing from the broader aspects of the present invention.

In practical application, an operator wishing to calibrate the camera 14 in accordance with a particular industry would chose the appropriate disk 22 and gray-scale markings 24, and secure the disk 22 to the light shroud 16 prior to executing image capture for the first time. Light reflected from the gray-scale markings 24 of the disk 22 would then be recorded by the camera 14. It is the acquired digital data from each reflected value from each of the gray-scale markings that would then be compared to a known lookup table, containing predetermined and known digital data specific to the calibration disk 22 that is utilized, to determine if the recorded values are consistent with the values stored in the table.

Preferably, the comparison between the recorded reflected values and the values of the appropriate lookup table is accomplished via a software program/application that had previously been loaded into, and integrated with, the operating system of the cell phone 10. It will be readily appreciated however that the comparison itself could be equally accomplished by transmitting the recorded reflected values, via wireless or wired communication, to a comparison system not integrated with the cell phone 10, without departing from the broader aspects of the present invention.

Once the initial image capture and comparison is completed, the integrated software program/application is thereafter capable of adjusting all future imaged values in accordance with the magnitude of any difference between what was recorded and the proper values for the particular gray-scale markings that were utilized during the calibration operation. That is, after the initial exposure and calibration operation, the disk 22 is removed from the light shroud 16 and subsequent images captured by the camera 14 are adjusted utilizing the data obtained from the calibration operation.

It is therefore another important aspect of the present invention that the calibration operation ensures that the color values of all future images are accurate, regardless of the age, technology or type of camera 14 that is used to capture the images. Indeed, by utilizing the same disk 22, it is possible to ensure that differing devices, whether they be differing cell phone cameras or tablet cameras or any other digital data gathering devices, all record consistent and accurate color values when imaging the same surface or item. Moreover, by simply choosing the proper calibration disk, representing the specific color or gray-scale for a particular industry or manufacturer, an operator can ensure that the data acquired by any technological platform with such a calibrated digital data gathering device will acquire data that is uniform and consistent with the data gathered by any other digital data gathering device that was also calibrated using the same disk.

It will be readily appreciated that the ability to obtain consistent and accurate color values, regardless of the type or kind of digital data gathering device utilized, enables an operator to rely upon the recorded color values of any such calibrated device when color matching is desired. In practice, this ability to calibrate any digital data gathering device to obtain accurate color values is essential when attempting to compare and match fabrics or paints, or when imaging is utilized in medical applications and/or diagnostic operations.

It is yet another important aspect of the present invention that highly accurate color matching can be accomplished utilizing commonly known and carried devices, such as cell phones and tablet devices with integrated digital cameras, without the need for expensive or cumbersome stand alone devices.

Indeed, although the present invention has been described in connection with cell phones, smart phones and/or tablet devices, it should be readily appreciated that the present invention is equally applicable to any device, of whatever design, technology or platform, which itself is integrated with a digital data gathering device.

As described herein, the present invention discloses a method of calibrating the acquired data from a digital data gathering device (i.e., digital camera or the like) by first providing a uniform light-tight environment to the digital data gathering device, and then proceeding to calibrate the resultant acquired data in accordance with acquired grey/color scale data, thus ensuring that acquired data from the same or differing devices can be compared and measured against one another against a common standard.

While one embodiment the light shroud 16 has been depicted in FIGS. 1-3, it will be readily appreciated that the light shroud 16 could have any size or configuration without departing from the broader aspects of the present invention, provided the light shroud effectively blocked out all ambient light during the calibration operation. Indeed, the light shroud 16 need not be rigid as shown in FIGS. 1-3, and could instead function as a telescoping and/or collapsible cone. Moreover, the light shroud 16 could enjoy any particular shape or size, or diameter(s), and could alternatively be square, triangular or rectangular, without departing from the broader aspects of the present invention. The light shroud 16 could also be fashioned from a range of materials, including paper or cardboard materials, or made disposable or recyclable, without departing from the broader aspects of the present invention.

Likewise, while illumination elements such as LED's have been described, alternative embodiments of the present invention involve utilizing the built-in flash of a cell phone or tablet device to illuminate the inner cavity of the light shroud 16 during the calibration operation, either directly or as reflected by suitable material surface mounted to the inner wall of the light shroud 16. If so utilized, the present invention also envisions potentially altering the intensity, direction or duration of any built-in flash element used to illuminate the light shroud during the calibration operation. Fiber optics could also be utilized to direct or route light from the built-in flash to any part of the light shroud 16, without departing from the broader aspects of the present invention.

It is also envisioned that the light shroud could be fashioned from material that is capable of broadcasting stored light, so that it would be the light shroud itself, or a portion thereof, that provided the illumination for the calibration operation. Moreover, the distal annular edge 20 of the light shroud 16 may be fashioned from a resilient yet deformable material, so that when pressed against a surface to be imaged, the edge 20 would adapt and accommodate non-uniform or textured surfaces, thus ensuring the light-tight environment for the light shroud 16 during the calibration and subsequent imaging operations.

The present invention therefore enables a smart phone camera (or other digital data gathering device, in a tablet or the like) to produce accurate and consistent color data by precisely controlling the primary factors needed to capture consistent color data, such as: (1) The lighting volume, angle and the associated color temperature of the light used to illuminate the surface or item being measured; (2) The ambient light environment surrounding the color surface being measured; and (3) The absolute control, consistency and repeatability of light exposure and focus to the camera CMOS chip (or, CCD chip, or any other known or as yet undeveloped image detection sensor or detector), regardless of the surface or item being measured. By effectively managing these three factors, the present invention enables a smart phone digital camera (or any other apparatus having a digital data gathering device incorporated therein, or in communication therewith) to become a very accurate and consistent color measurement tool.

While the calibration disk 20 has been described as exhibiting an industry standard gray-scale for use during the calibration operation, the term “gray-scale” is meant to encompass any industry standard markings, including a spectrum of small color patches designed to first confirm that the LED light source is within tolerance and then evaluate how, e.g., each smart phone CMOS chip is reacting to the controlled light it is receiving. Software analysis of the resulting color data, via the integrated calibration software/application, enables the smart phone CMOS chip to be profiled. The profile is then compared to the color master data profile in order to produce consistent data between various smart phones as well as various color spaces. The profiled data made possible by the present invention will enable both professionals and average consumers to inexpensively and intuitively incorporate the use of color reference information into all facets of everyday life.

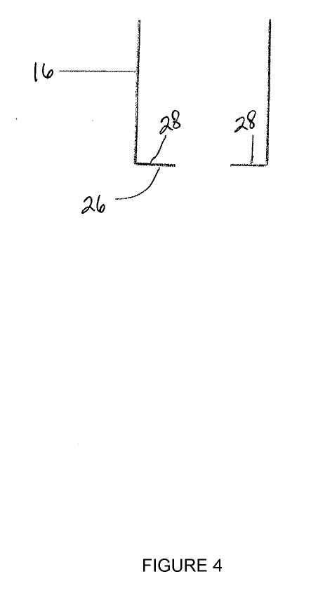

In yet another alternative embodiment of the present invention, the calibration disk 22 need not be a separate element, but rather could be integrated into the body of the light shroud 16, such as shown in FIG. 4. As shown in FIG. 4, the walls of the light shroud 16 are schematically depicted in cross-section and include an inwardly extending annular flange 26. The inside surface 28 of the flange 26 could then carry the gray-scale/color markings, thereby providing the necessary reflected image to enable the accurate calibration of the digital data gathering device to which it was attached. If so utilized, the image of the annular flange 26 and color markings 28 could be selectively edited out of subsequent recorded images, via the integrated calibration software/application.

In yet another embodiment of the present invention, the light shroud 16 of the present invention may also include an internal light sensor that is capable of sensing whether there is any ambient light leaking into the light shroud 16 during a calibration or imaging operation. If so, the integrated calibration software/application would alert the operator to the presence of the contaminating leakage and perform the exposure operation again until such a time that no such contamination was detected.

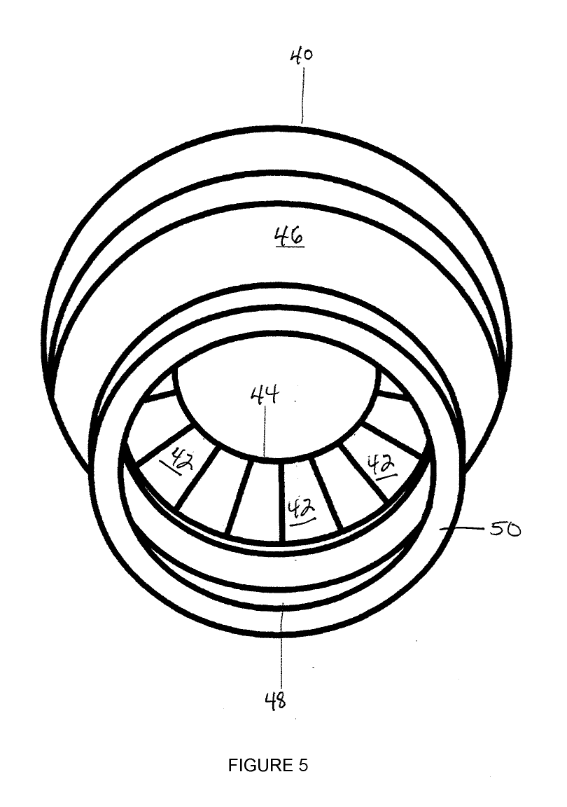

FIG. 5 illustrates one alternative embodiment of a light shroud 40 having a plurality of calibration markings 42 formed on an inner annular surface 44. As shown in FIG. 5, the light shroud 40 has an articulated enclosing wall 46, which may be selectively collapsible or telescopic in nature, and may also include a light sensor 48, for determining the presence of any ambient light within the light shroud 40 during a calibration and/or data gathering operation. While the light sensor 48 is shown as being physically located within the light shroud 40, the light senor 48 may be located remotely from and outside the light shroud 40, provided that it remains in communication with the interior of the light shroud 40, without departing from the broader aspects of the present invention. As will be appreciated, the light shroud 40 defines a lens-side profile 50 that, in operation, substantially surrounds the lens of the digital data gathering device, whether by virtue of the light shroud 40 being an integral part of the removable protective case 12, or as a stand-alone element, without departing from the broader aspects of the present invention.

In practical application, the present invention is envisioned to be of great utility in the home consumer markets, where color matching between interior or exterior paints or fabrics is desired, as well as in professional manufacturing markets where color matching to a contract specification or the like is required.

While the present invention has been described as being able to collect accurate and industry-accepted data from a calibrated, light-tight scanning operation of a digital gathering device, and to make such scanning and data gathering operations uniform across differing technological platforms or devices, the present invention is not so limited in this regard. That is, it is also envisioned to utilize the present invention as a comparative evaluator, such as when comparing one digitally captured image to a known ‘standard’ or ‘control’ sample, regardless of the nature of the digital data that is gathered.

In such a comparison operation, the light shroud of the present invention would encompass at least two separate chambers, such that each chamber is positioned above one of the digital image and the control sample, respectively. Once an image capture operation has been effectuated, the software in communication with the digital data gathering device will then compare the color/shade valuations obtained from imaging the digital image, with the results obtained from imaging the control sample, to determine how closely the digital image meets the expected color/shade of the control sample.

In an alternative embodiment, the light shroud would be a single chamber, large enough for at least two images to be encompassed inside. Then, image capture would be effectuated, with a comparison of the parameters of the two acquired images.

In this manner, the present invention is capable of providing a comparative function where the data comparison is not only between an industry-standard gray-scale and an acquired digital image, but also between any two items or samples. Thus, whether the acquired digital image is compared to a chosen industry-specific gray-scale, or to another acquired image, the present invention is capable of making any digital data gathering device into a reliable and efficient comparison tool, through the disclosed process of light-tight calibration and subsequent evaluation and comparison.

While the light shroud and enclosing wall 16 has been described, it will be readily appreciated that additional functionality and operability may be obtained by associating additional software with the evaluation apparatus of the present invention. Moreover, it will be readily appreciated that any processing or operational software may be integrated with, and/or supported by, the digital data gathering device itself, or remotely, without departing from the broader aspects of the present invention.

In particular, in order for the digital data gathering device to accumulate digital data on an object that has a surface to be examined that is larger than is encapsulated by the light shroud and enclosing wall 16, the present invention contemplates alternative embodiments of the present invention in which software enables the light shroud and enclosing wall 16 to be moved, or slid, across a surface of an object in a way that “builds” the increased image area as the cylinder is slid from left to right, right to left, top to bottom etc. This type of image “building” can be performed using known panoramic stitching functionalities supported on known digital cameras/smartphones and tablets. In this manner, a consistently lit, controlled and calibrated exposure of a large surface can be performed during one exposure, eliminating the potential inconsistency issues associated with capturing multiple images to cover a larger image area.

In yet another alternative embodiment of the present invention, it is certainly possible to utilize filters to eliminate surface glare and provide even illumination and balanced color temperature, as necessary. In this regard, the present invention also contemplates positioning various forms of filters integrated into the light shroud and enclosing wall 16, in order to control the lighting and camera lens of the image capturing device. The types of filters may be chosen from any known light filtering devices, including but limited to, for example, polarizing filters, color filters, light scattering filters, etc.

One practical use of the evaluation apparatus of the present invention can be seen in its applicability in the realm of internet (or, retail) shopping and color matching. Thus, in use, an operator would selectively attached or engage the light shroud and enclosing wall 16 to the digital data gathering device, such that the light shroud and enclosing wall 16 substantially encapsulates the camera lens of the digital data gathering device.

After affixing the light shroud and enclosing wall 16, the operator will make use of the calibration markings (whether on a calibration disk 22, or otherwise) to properly calibrate the digital data gathering device, in accordance with the preceding description. After calibration, the operator can then utilize the digital data gathering device and affixed light shroud 16 to image/data capture an object to, for example, obtain a color value/determination of the object.

Once an operator has a given color value for the imaged object, associated software (i.e., software applications capable of running remotely via wired or wireless internet communication, or being integrated with the digital data gathering device itself) may be employed to use this color value/determination (and a general ‘subject’ data input such as “drapes”), to search the internet for matching articles, namely, drapes having the same or similar color values. In this manner, an operator cannot only be satisfied that they have received an accurate color evaluation of the imaged object, but can also utilize this information to search the internet for the same or similar values in whatever context, or desired article, that is desired.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A system for harmonizing uniform light evaluation results between a plurality of separate digital data gathering devices, the system comprising:
a first digital data gathering device and a second digital data gathering device each having a lens through which the digital data gathering devices are operative to accept incoming light during exposures; and
a calibration device operative to perform a first initial calibration of the first digital data gathering device during a first initial calibration exposure of the first digital data gathering device, and to perform a second initial calibration of the second digital data gathering device during a second initial calibration exposure of the second digital data gathering device; and
wherein the first and the second digital data gathering devices are operative to obtain and to adjust subsequent exposures in dependence upon the first and the second initial calibrations, respectively, such that the subsequent exposures obtained by the first and the second digital data gathering devices are harmonized with one another.

2. The system according to claim 1, wherein:
at least one of said first and said second digital data gathering devices is one of a digital camera, a tablet device and a smart phone.

3. The system according to claim 2, further comprising:
a light shroud having an enclosing wall operative to substantially surround the lens of at least one of the first digital data gathering device and the second digital data gathering device and to extend a predetermined distance outwardly therefrom so as to define a distal edge portion;
an illumination source in selective communication with an interior of the light shroud thereby preventing ambient light from entering the interior of the light shroud when a substantial entirety of the distal edge portion of the enclosing wall is in touching contact with an object; and
wherein said light shroud is selectively positionable between a first position and a second position, said first position where said light shroud substantially surrounds said lens of said digital camera, and said second position where said light shroud does not substantially surround said lens.

4. The system according to claim 3, wherein:
said illumination source is one of an array of one or more LED's arranged within said interior of said light shroud, and a flash apparatus of said first or said second digital data gathering devices.

5. The system according to claim 3, wherein:
said calibration device comprises one or more color patches arranged to be exposed to said light issuing from said illumination device and captured within said light shroud.

6. The system according to claim 3, wherein:
said calibration device is a calibration disk, said calibration disk having at least one marking thereon such that said illumination reflects from said marking and is received through said lens of said first or said second digital data gathering devices.

7. The system according to claim 6, wherein:
said calibration disk is removably affixed to said distal edge portion of said shroud.

8. The system according to claim 6, wherein:
said at least one calibration marking is comprised of a plurality of gray scale markings.

9. The system according to claim 6, wherein:
said at least one calibration marking is comprised of a plurality of color shade markings.

10. The system according to claim 3, wherein the calibration device further comprises:
calibration markings arranged about an inner surface of said enclosing wall, said calibration markings being exposed to illumination issuing from said illumination device such that said illumination reflects from said calibration markings and is received through said lens of said first or said second digital data gathering devices.

11. The system according to claim 3, wherein the calibration device further comprises:
an ambient light sensor, said ambient light sensor being arranged to be in communication with said interior of said light shroud, said ambient light sensor indicating when said ambient light is present within said interior when said substantial entirety of said distal edge portion of said light shroud is in touching contact with said object.

12. A calibration method for harmonizing data evaluation by a first and a second digital data gathering device, said calibration method comprising the steps of:
defining a plurality of regions on a calibration insert;
selectively placing said calibration insert in communication with a field of view of said first digital data gathering device during an initial calibration exposure, said initial calibration exposure obtaining first digital data related to said regions of said calibration insert;
altering subsequent digital data gathering by said first digital data gathering device in dependence upon said first digital data;
selectively placing said calibration insert in communication with a field of view of said second digital data gathering device during an initial calibration exposure, said initial calibration exposure obtaining second digital data related to said regions of said calibration insert;
altering subsequent digital data gathering by said second digital data gathering device in dependence upon said second digital data; and
wherein said subsequent digital data gathering of said first and said second digital data gathering devices are thereby harmonized with one another.

13. The calibration method according to claim 12, said calibration method further comprising the steps of:
removing said calibration insert from said field of view of said first digital data gathering device after said initial calibration exposure; and
removing said calibration insert from said field of view of said second digital data gathering device after said initial calibration exposure.

14. A calibration apparatus for harmonizing data evaluation between a first and a second digital data gathering device, said calibration apparatus comprising:
a calibration insert having a plurality of regions defined thereon;
a first mounting attachment for selectively mounting said calibration insert to be in communication with a field of view of said first digital data gathering device during an initial calibration exposure, said initial calibration exposure obtaining first digital data related to said regions of said calibration insert;
a second mounting attachment for selectively mounting said calibration insert to be in communication with a field of view of said second digital data gathering device during an initial calibration exposure, said initial calibration exposure obtaining second digital data related to said regions of said calibration insert;
wherein subsequent digital data gathering by said first digital data gathering device is altered in dependence upon said first digital data, and subsequent digital data gathering by said second digital data gathering device is altered in dependence upon said second digital data, thereby harmonizing said data evaluation between said first and said second digital data gathering devices.

15. A method for enabling accurate internet product matching and identification of an object, said method comprising the steps of:
positioning a calibration insert in the field of view of a digital data gathering device;
performing an initial calibration exposure of said calibration insert to obtain digital data related thereto;
performing a subsequent exposure operation of said object, said exposure operation storing digital characteristics of said object as altered in dependence upon said digital data;
accessing the internet; and
searching for said object via said internet utilizing said altered and stored digital characteristics of said object.

16. The method for enabling accurate internet shopping according to claim 15, further comprising the steps of:
removing said calibration insert from said field of view during said subsequent exposure operation.

17. The method for enabling accurate internet shopping according to claim 15, further comprising the steps of:
defining a plurality of regions on said calibration insert.

18. The method for enabling accurate internet shopping according to claim 15, wherein:
said digital characteristics of said object include one of color, texture and health information.

19. A method for enabling accurate internet product matching and identification of an object, said method comprising the steps of:
utilizing a digital data gathering device to capture color data of an object;
accessing an internet portal capable of receiving said color data;
providing a portal for entry of a desired object identifier; and
searching the internet to find products that match said desired object identifier and said color data.
